(19) United States
(12) Patent Application Publication
(10) Pub. No.: US 2026/0112733 A1
(43) Pub. Date: Apr. 23, 2026

(54) COOLER AND METHOD FOR MANUFACTURING BATTERY PACK

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/311,528

(22) Filed: Aug. 27, 2025

(30) Foreign Application Priority Data
Oct. 22, 2024 (JP) 2024-186151

(51) Int. Cl. H01M 10/6557; H01M 10/613; H01M 10/6567

(52) U.S. Cl. CPC H01M 10/6557; H01M 10/613; H01M 10/6567

(57) ABSTRACT

A cooler disposed inside a case that houses a battery includes a cooling section disposed between adjacent ones of the batteries in a stacking direction. The cooling section includes a plurality of ribs each extending so as to connect a first inner surface of a first cooling surface and a second inner surface of a second cooling surface. The ribs are deformable in response to a change in the distance between the first inner surface and the second inner surface. The ribs include a pair of ribs configured to deform to move away from each other when the distance between the first inner surface and the second inner surface changes in a direction in which the distance increases, and configured to deform to move toward each other when the distance between the first inner surface and the second inner surface changes in a direction in which the distance decreases.

### CROSS-REFERENCE TO RELATED APPLICATION

This application claims priority to Japanese Patent Application No. 2024-186151 filed on October 22, 2024. The disclosure of the above-identified application, including the specification, drawings, and claims, is incorporated by reference herein in its entirety.

### BACKGROUND

### 1. Technical Field

The present disclosure relates to coolers and to methods for manufacturing a battery pack.

### 2. Description of Related Art

Japanese Unexamined Patent Application Publication (Translation of PCT Application) No. 2024-509489 (JP 2024-509489 A) discloses a battery pack in which a cooling device for cooling battery cells is provided inside a case that houses a plurality of battery cells. In the configuration described in JP 2024-509489 A, the cooling device includes a plurality of coolers, and the coolers and the battery cells are alternately stacked.

Japanese Unexamined Patent Application Publication (Translation of PCT Application) No. 2016-537799 (JP 2016-537799 A) discloses that a pre-bent rib is provided inside a heat exchange tube through which a coolant flows. The rib has a linear or curved shape inclined with respect to a main side surface.

### SUMMARY

In a structure in which battery cells and coolers are alternately stacked as in the configuration described in JP 2024-509489 A, the battery cells expand during use, causing the coolers to deform and be compressed. In this case, when the coolers are significantly compressed, coolant channels provided inside the coolers become narrower, resulting in reduced cooling performance.

Although JP 2016-537799 A discloses that the heat exchange tube is formed in a flat shape including two main side surfaces and edge portions. However, it does not disclose anything regarding changes in thickness of the heat exchange tube during battery use etc.

The present disclosure has been made in consideration of the above circumstances, and an object thereof is to provide a cooler and a method for manufacturing a battery pack that can reduce the possibility of a battery moving in a height direction when the thickness of the cooler changes, while reducing the possibility of collapse of a coolant channel during battery use.

A cooler according to the present disclosure is a cooler disposed inside a case that houses a battery and configured to cool the battery. The cooler includes a cooling section disposed in a stack of a plurality of the batteries at a position between adjacent ones of the batteries in a stacking direction of the stack. The cooling section includes: a channel through which coolant flows in a width direction perpendicular to the stacking direction; a first cooling surface that contacts one of the adjacent batteries; a second cooling surface that contacts the other of the adjacent batteries; and a plurality of ribs each extending so as to connect a first inner surface that is a back surface of the first cooling surface and a second inner surface that is a back surface of the second cooling surface. The ribs are deformable in response to a change in the distance between the first inner surface and the second inner surface. The ribs include a pair of ribs configured to deform to move away from each other when the distance between the first inner surface and the second inner surface changes in a direction in which the distance increases, and configured to deform to move toward each other when the distance between the first inner surface and the second inner surface changes in a direction in which the distance decreases. The pair of ribs is configured to contact each other when the battery expands and the distance between the first inner surface and the second inner surface is reduced to a predetermined amount, and in a state in which the pair of ribs is in contact with each other, support each other such that the first inner surface and the second inner surface do not come any closer.

A method for manufacturing a battery pack according to the present disclosure is a method for manufacturing a battery pack including the cooler according to the present disclosure. The method includes an insertion step of, in a state in which a cooling device is placed inside a case that houses a plurality of battery cells, inserting each of the battery cells between corresponding adjacent ones of the coolers. The cooling device includes a structure in which the coolers are arranged such that cooling surfaces of the coolers face each other. The method further includes a deformation step of, after insertion of each of the battery cells between the corresponding adjacent ones of the coolers, increasing internal pressure of the cooler to deform the cooler such that the cooling surface comes into contact with the battery cell. In the insertion step, the pair of ribs inside the cooler is in a separated state. The deformation step includes deforming the pair of ribs such that the pair of ribs moves away from each other and displacing the cooling surface in the stacking direction as the cooler is deformed to increase the thickness of the cooler.

The present disclosure can reduce the possibility of a battery moving in the height direction when the thickness of a cooler changes, while reducing the possibility of collapse of a coolant channel during battery use.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a battery pack according to an embodiment;

FIG. 2 illustrates a cooling device;

FIG. 3 illustrates a cooler;

FIG. 4 illustrates a cooling section;

FIG. 5 shows cross-sectional views, where part (a) illustrates the shape of the cooling section in an extruded state, and part (b) illustrates the shape of the cooling section in a deformed state after pressure has been applied to the interior of the cooler in a deformation step; and

FIG. 6 shows cross-sectional views, where part (a) illustrates the shape of the cooling section during battery use, and part (b) illustrates a state in which the battery cells have expanded during battery use and each pair of ribs inside the cooling section is supporting each other.

### DETAILED DESCRIPTION OF EMBODIMENTS

A cooler and a method for manufacturing a battery pack according to an embodiment of the present disclosure will be described in detail below. The present disclosure is not limited to the embodiment described below.

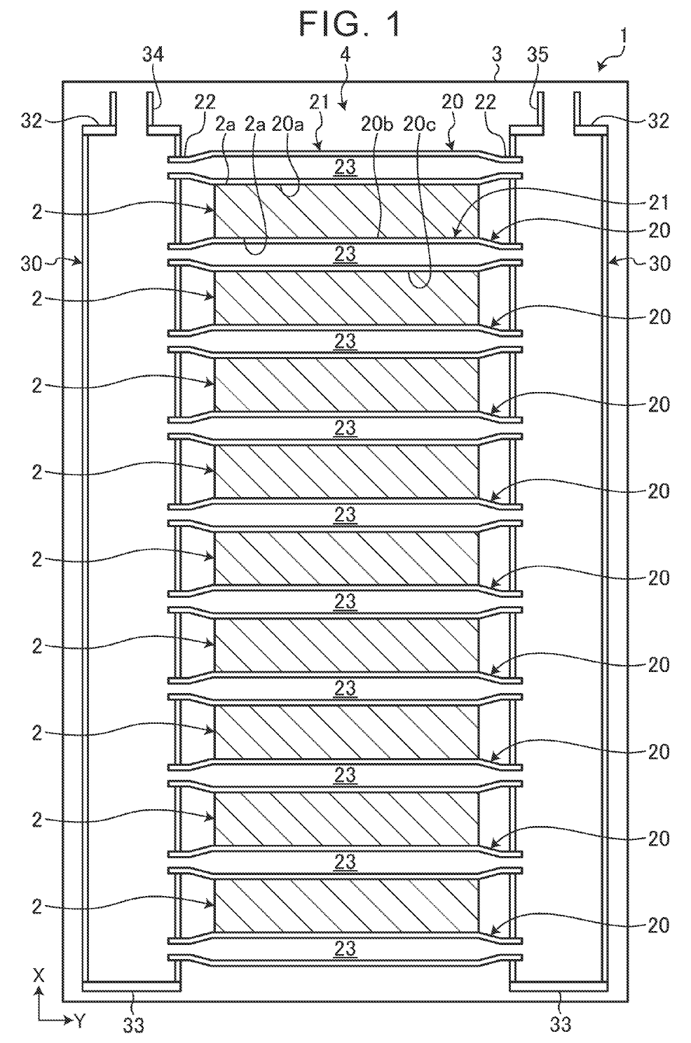

FIG. 1 schematically shows a battery pack according to the embodiment. The battery pack 1 includes a plurality of battery cells 2, a case 3, and a cooling device 4. The battery pack 1 is mounted in an electrified vehicle. The electrified vehicle equipped with the battery pack 1 travels by supplying electric power stored in the battery pack 1 to a traction motor.

The battery cells 2 are cells formed in a rectangular parallelepiped shape. Among the surfaces of each battery cell 2, the one with the largest area is a flat surface 2a. The battery cells 2 are arranged inside the case 3 such that their flat surfaces 2a face an X-direction. Inside the case 3, the battery cells 2 are stacked in the X-direction. The X-direction is the same as the stacking direction of the stack of the battery cells 2.

The case 3 is a battery pack case that houses the battery cells 2 and the cooling device 4. Inside the case 3, the battery cells 2 form a battery module. The case 3 is capable of housing a plurality of the battery modules.

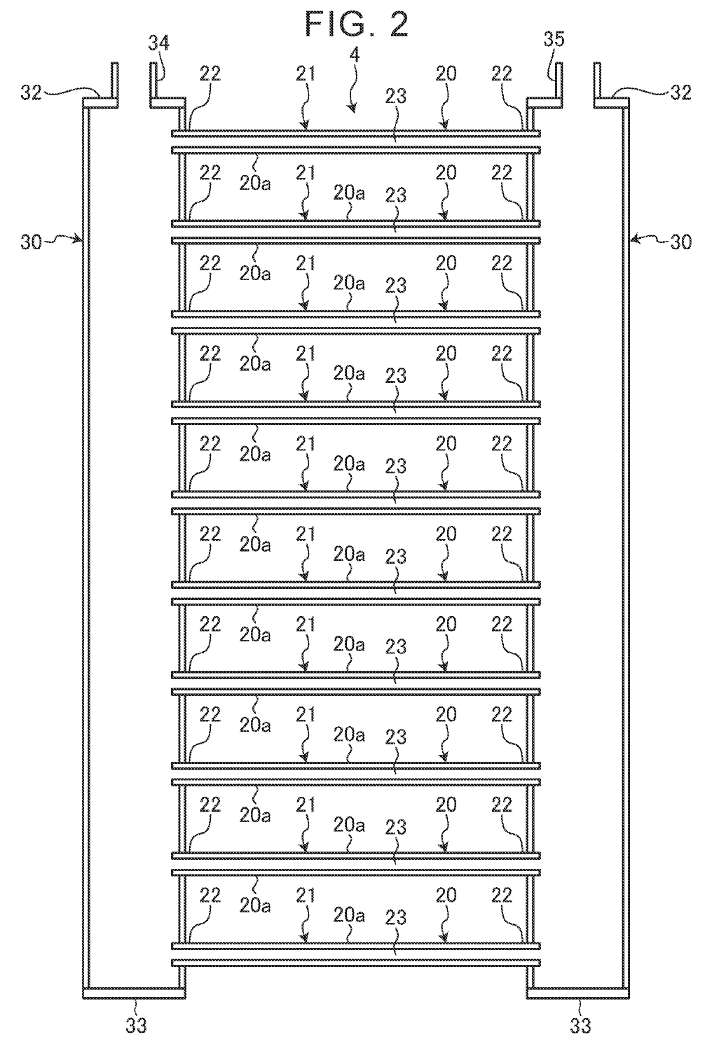

The cooling device 4 cools the battery cells 2 using a coolant. The cooling device 4 includes a cooler 20 and a pipe 30. As shown in FIG. 2, the cooling device 4 is an integrated structure in which a plurality of the coolers 20 is joined to a pair of the pipes 30.

The coolers 20 are stacked alternately with the battery cells 2 and cool the battery cells 2. Each cooler 20 is formed from a metal extrusion. The coolers 20 extend in a Y-direction. The Y-direction is perpendicular to the X-direction. The Y-direction is the same direction as the width direction of the battery cell 2. The width direction is perpendicular to the stacking direction. Each cooler 20 has cooling surfaces 20a each contacting a corresponding one of the battery cells 2. The cooling device 4 has a structure in which the cooling surfaces 20a of the coolers 20 face each other. Each cooling surface 20a contacts the flat surface 2a of a corresponding one of the battery cells 2.

The pipes 30 are rectangular pipes extending in the X-direction. Each pipe 30 is formed from a metal extrusion. The coolers 20 are connected to each pipe 30.

As shown in FIG. 1, in the completed state of the battery pack 1, a stack is formed inside the case 3 in which the coolers 20 and the battery cells 2 are alternately stacked in the-X direction, with the coolers 20 located at both ends of the stack in the stacking direction. The stacking direction is the same direction as the X-direction. Since the battery cells 2 have a prismatic shape and the coolers 20 have a flat plate shape, each battery cell 2 is sandwiched between two coolers 20. The battery cells 2 and the coolers 20 are stacked such that the surfaces with the largest area among their respective surfaces are in contact with each other. The cooling surfaces 20a include a first cooling surface 20b that contacts one of adjacent battery cells 2 and a second cooling surface 20c that contacts the other of the adjacent battery cells 2. The first cooling surface 20b and the second cooling surface 20c may be collectively referred to as the cooling surface(s) 20a unless otherwise distinguished.

Each cooler 20 includes a cooling section 21 and connection sections 22. In each cooler 20, the cooling section 21 is a part that includes the cooling surfaces 20a, and the connection sections 22 are parts that do not include the cooling surfaces 20a.

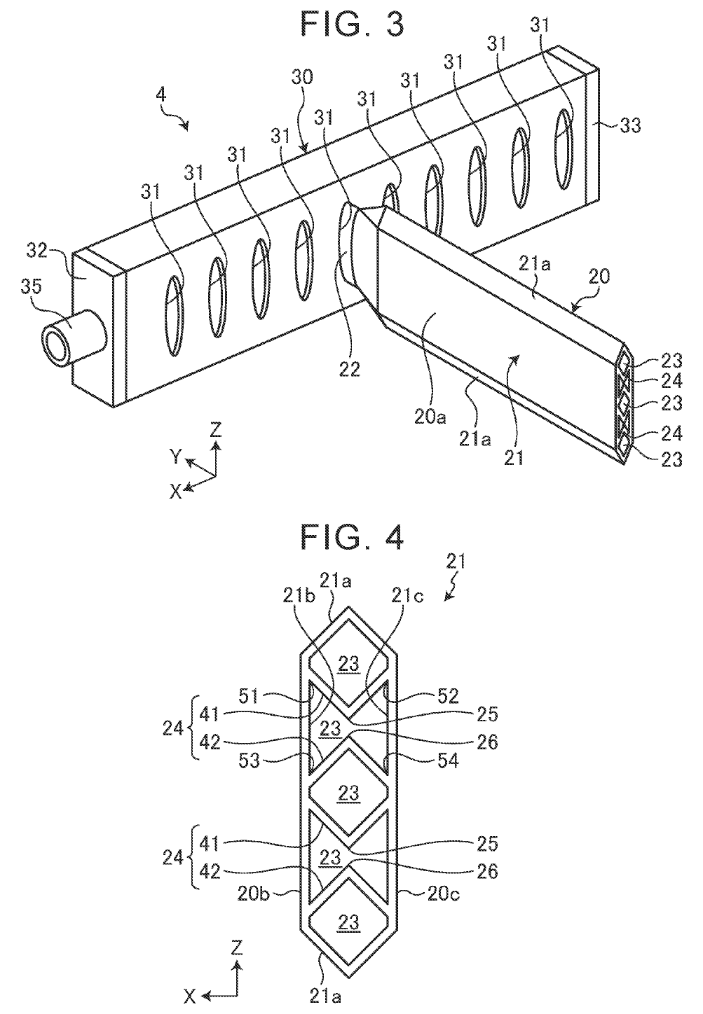

The cooling section 21 is disposed between adjacent battery cells 2 in the stacking direction, and forms a stack together with the battery cells 2. As shown in FIG. 3, each cooling section 21 is a multi-hole tube formed in a hollow flat-plate shape and extending in the Y-direction.

A channel 23 through which coolant flows and a plurality of ribs 24 are provided inside the cooling section 21. The channel 23 extends along the Y-direction, and the coolant flows in the Y-direction. The internal space of the cooling section 21 serves as the channel 23 for the coolant. The channel 23 is formed by the internal space between opposing back surfaces of the cooling surfaces 20a and is partitioned in the Z-direction by the ribs 24. The Z-direction is perpendicular to both the X- and Y-directions. The Z-direction is the same direction as the height direction of the battery cells 2. The ribs 24 extend so as to connect the opposing back surfaces of the cooling surfaces 20a. The ribs 24 are provided in the region where the cooling surfaces 20a extend in the Y-direction.

The connection sections 22 are formed at both ends of the cooling section 21 in the Y-direction and are each connected to a corresponding one of the pipes 30. Each connection section 22 has a single channel that is not partitioned in the Z-direction. The channel of each cooler 20 is formed such that it branches from the channel in the upstream-side connection section 22 into the channels 23 in the cooling section 21 and merges into the channel of the downstream-side connection section 22 from the cooling section 21. In the cooling device 4, the coolers 20 are arranged such that their cooling surfaces 20a face each other, and the connection sections 22 of the coolers 20 are joined to the pipes 30.

Each pipe 30 has a plurality of connection ports 31. Each pipe 30 is formed by extrusion, and the connection ports 31 are opened by machining. Each connection port 31 is an opening that opens in the Y-direction, and the connection section 22 of a corresponding one of the coolers 20 is connected to each connection port 31. The coolers 20 are joined to each pipe 30 such that their connection sections 22 are fitted in the connection ports 31.

A first end cap 32 and a second end cap 33 are joined to the each of the pipes 30. The first end cap 32 is joined to the pipe 30 so as to cover one open end of the pipe 30 in the X-direction. The second end cap 33 is joined to the pipe 30 so as to cover the other open end of the pipe 30 in the X-direction. As shown in FIGS. 1 and 2, a first pipe section 34 is joined to the first end cap 32 of one of the pipes 30, and a second pipe section 35 is joined to the first end cap 32 of the other pipe 30. The first pipe section 34 is an inlet-side pipe section. The coolant supplied to the cooling device 4 flows into the interior of the cooling device 4 through the first pipe section 34. The second pipe section 35 is an outlet-side pipe section. The coolant discharged from the cooling device 4 flows out of the cooling device 4 through the second pipe section 35.

In the cooling device 4, the cooling sections 21 are deformable such that their cooling surfaces 20a are displaced in the X-direction in response to the internal pressure in the cooler 20. The coolers 20 are configured to deform such that their thickness in the X-direction increases. FIG. 2 shows the coolers 20 prior to deformation, in which their thickness in the-X direction remains small. FIG. 1 shows the coolers 20 after deformation, in which their thickness in the-X direction has increased. The coolers 20 are fabricated in a thinner state than during use, and are brazed to the pipes 30.

As shown in FIG. 3, the cooling section 21 includes deformable portions 21a. The deformable portions 21a are portions that deform so as to change the thickness of the cooling section 21 in the X-direction. The deformable portions 21a are formed in a shape inclined with respect to both the X-direction and the Z-direction. The deformable portions 21a include a deformable portion 21a formed in an inverted V-shape on one side in the Z-direction and a deformable portion 21a formed in a V-shape on the other side in the Z-direction.

As shown in FIG. 4, in the extruded state, the cooling section 21 has a hexagonal outer shape. The outer shape of the cooling section 21 is defined by the cooling surfaces 20a and the deformable portions 21a. The ribs 24 are provided inside the cooling section 21.

Each rib 24 extends so as to connect a first inner surface 21b and a second inner surface 21c. The first inner surface 21b is the back surface of the first cooling surface 20b, and the second inner surface 21c is the back surface of the second cooling surface 20c. Each rib 24 includes a portion that protrudes relatively in the Z-direction between the first inner surface 21b and the second inner surface 21c. Each rib 24 is deformable in response to changes in the distance between the first inner surface 21b and the second inner surface 21c. In the cooling section 21, the deformable portions 21a and the ribs 24 deform. FIG. 4 shows the shape of the deformable portions 21a and the ribs 24 before deformation.

Each rib 24 includes a pair of ribs, that is, a first rib 41 including a first contact portion 25 and a second rib 42 including a second contact portion 26. The cooling section 21 illustrated in FIG. 4 is provided with two pairs of ribs 24.

The first rib 41 is connected to the first inner surface 21b at a first connection point 51, and is connected to the second inner surface 21c at a second connection point 52. The first contact portion 25 is located closer to the second rib 42 than the first connection point 51 and the second connection point 52. The portion between the first connection point 51 and the first contact portion 25 is formed in a linear shape inclined with respect to the X-direction. The portion between the second connection point 52 and the first contact portion 25 is also formed in a linear shape inclined with respect to the X-direction.

The second rib 42 is connected to the first inner surface 21b at a third connection point 53, and is connected to the second inner surface 21c at a fourth connection point 54. The second contact portion 26 is located closer to the first rib 41 than the third connection point 53 and the fourth connection point 54. The portion between the third connection point 53 and the second contact portion 26 is formed in a linear shape inclined with respect to the X-direction. The portion between the fourth connection point 54 and the second contact portion 26 is also formed in a linear shape inclined with respect to the X-direction.

In each pair of ribs 24, the distance between the first connection point 51 and the third connection point 53 is smaller than the sum of the distance from the first connection point 51 to the first contact portion 25 and the distance from the third connection point 53 to the second contact portion 26. Similarly, in each pair of ribs 24, the distance between the second connection point 52 and the fourth connection point 54 is smaller than the sum of the distance from the second connection point 52 to the first contact portion 25 and the distance from the fourth connection point 54 to the second contact portion 26.

As shown in FIG. 4, in the extruded state of the cooling section 21, the first rib 41 and the second rib 42 are separated from each other. The first rib 41 and the second rib 42 face each other in the Z-direction, with their respective contact portions located close to each other. In each pair of ribs 24, the first contact portion 25 and the second contact portion 26 are capable of contacting each other. When the first contact portion 25 and the second contact portion 26 come into contact with each other, the pair of ribs 24 contacts each other.

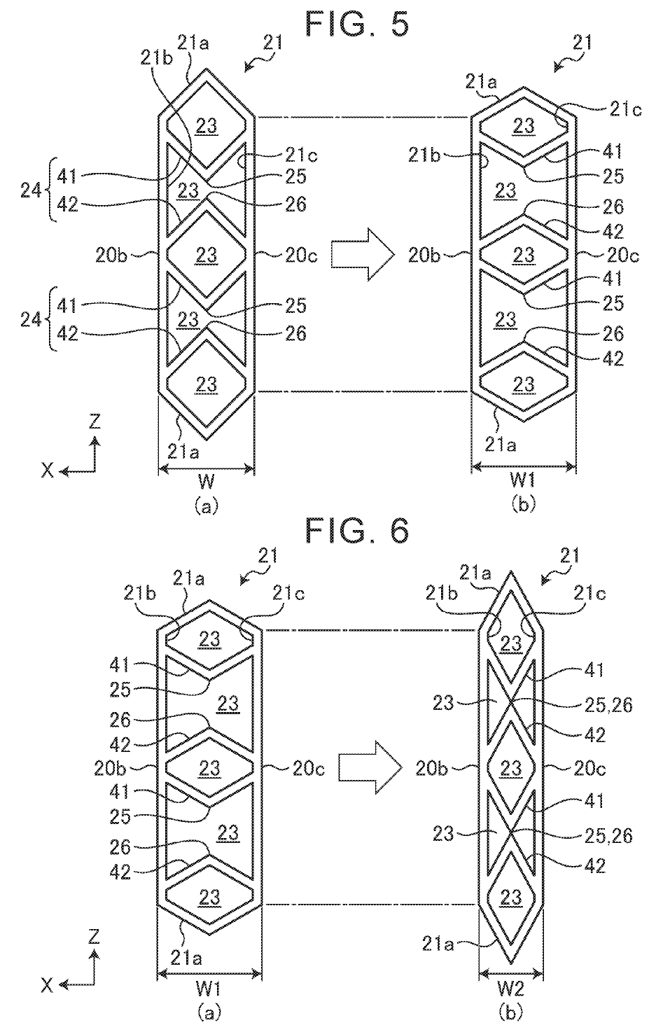

As shown in FIGS. 5 and 6, each rib 24 includes a pair of ribs that deforms to move away from each other when the distance between the first inner surface 21b and the second inner surface 21c changes in a direction in which it increases, and that deforms to move toward to each other when the distance between the first inner surface 21b and the second inner surface 21c changes in a direction in which it decreases. When the battery cells 2 expand and the distance between the first inner surface 21b and the second inner surface 21c is reduced to a predetermined amount, each pair of ribs 24 comes into contact with each other, and in this contacting state, support each other such that the first inner surface 21b and the second inner surface 21c do not come any closer. The predetermined amount is set to the distance corresponding to the state in which the first inner surface 21b and the second inner surface 21c are separated from each other.

The method for manufacturing the battery pack 1 includes a joining step, a placement step, an insertion step, and a deformation step. In this method, after the battery cells 2 and the cooling device 4 are housed in the case 3, pressure is applied to the interior of each cooler 20 to expand the cooling sections 21, thereby bringing the cooling sections 21 into close contact with the battery cells 2.

The joining step is a step of joining the coolers 20 to the pipes 30. In the joining step, the cooling device 4 is formed as an integral structure by joining its components such that the cooling surfaces 20a of the coolers 20 face each other. The cooling device 4 produced by the joining step is shown in FIG. 2.

The placement step is a step of placing the cooling device 4 as an integral structure inside the case 3. In the placement step, the cooling device 4 is placed in the case 3 in which the battery cells 2 have not yet been installed.

The insertion step is a step of inserting each battery cell 2 between corresponding adjacent ones of the coolers 20. In the insertion step, with the cooling device 4 arranged inside the case 3 such that the coolers 20 face each other, each battery cell 2 is inserted between corresponding adjacent ones of the coolers 20. When each battery cell 2 is inserted, there is a clearance between the battery cell 2 and each of its corresponding adjacent coolers 20. Before the battery cells 2 are inserted, the coolers 20 are in a thin state. The coolers 20 are extruded in this thin shape. In the insertion step, in a state in which the coolers 20 are not deformed, each battery cell 2 is placed in a position within the space between the corresponding opposing cooling surfaces 20a such that the flat surfaces 2a do not contact the cooling surfaces 20a. In the insertion step, each pair of ribs 24 inside each cooler 20 is in a separated state.

The deformation step is a step of expanding the cooling sections 21 by increasing the internal pressure of the coolers 20. In the deformation step, after each battery cell 2 is inserted between the corresponding coolers 20, the internal pressure of the coolers 20 is increased to deform the coolers 20 such that the cooling surfaces 20a come into contact with the battery cells 2.

In the deformation step, after the cooling device 4 is placed inside the case 3, the second pipe section 35 is closed by a valve or the like, and coolant is supplied to the interior of the coolers 20 from the first pipe section 34 via a pump or the like, thereby pressurizing the interior of the cooler 20. As the internal pressure of the coolers 20 increases, the deformable portions 21a and the ribs 24 are deformed such that the channels 23 inside the coolers 20 expand in the X-direction.

When pressure begins to be applied to the interior of the coolers 20 in the deformation step, the coolers 20 begins to expand. As the coolers 20 are deformed so as to increase their thickness, each pair of ribs 24 is deformed so as to move away from each other, thereby displacing the cooling surfaces 20a in the stacking direction. The shapes of the deformable portions 21a and the ribs 24 allow the cooling sections 21 to expand in the X-direction such that the cooling surfaces 20a do not move the Z-direction. If the cooling surfaces 20a move in the Z-direction during the deformation step, it will cause the battery cells 2 in contact with the cooling surfaces 20a to be displaced in the Z-direction. This results in positional misalignment of the battery cells 2 in the Z-direction. To address this, each cooling section 21 is provided with ribs 24 having a shape that allows the cooling surfaces 20a to be displaced in the X-direction without causing displacement of the cooling surfaces 20a in the Z-direction.

As shown in part (a) of FIG. 5, in a state prior to deformation of the deformable portions 21a by the deformation step, the cooling section 21 has a small thickness in the X-direction. The thickness of the cooling section 21 before the deformation is W. As shown in part (b) of FIG. 5, in a state after deformation of the deformable portions 21a by the deformation step, the thickness of the cooling sections 21 in the X-direction is greater than before deformation. The thickness of the cooling section 21 after the deformation is W1. When pressure is applied to the interior of the cooler 20, the cooler 20 becomes fully expanded. In the deformation step, the cooling section 21 is deformed to increase its thickness in the X-direction, thereby bringing each of the cooling surfaces 20a into close contact with a corresponding one of the battery cells 2.

In the deformation step, the coolers 20 are deformed such that each cooling surface 20a comes into contact with the flat surface 2a of a corresponding one of the battery cells 2. After each battery cell 2 is inserted into the space between the corresponding opposing cooling surfaces 20a, coolant is supplied from a pump to the first pipe section 34, thereby increasing the internal pressure of the coolers 20. When the internal pressure of the coolers 20 increases and the coolers 20 are deformed such that the thickness of the cooling sections 21 in the X-direction increases, each of the cooling surfaces 20a can be brought into close contact with a corresponding one of the flat surfaces 2a. In the deformation step, each cooling surface 20a is brought into contact with a corresponding one of the battery cells 2 to form a stack of the coolers 20 and the battery cells 2, and the battery cells 2 are compressed by the coolers 20 in the stacking direction.

As shown in part (a) of FIG. 6, when each pair of ribs 24 remains separated during battery use, the thickness of the cooling section 21 is W1. As shown in part (b) of FIG. 6, when the cooling section 21 is compressed in the X-direction due to expansion of the battery cells 2, the thickness of the cooling section 21 in the X-direction becomes smaller. When each pair of ribs 24 comes into contact with each other due to the expansion of the battery cells 2, the thickness of the cooling section 21 is W2. The thickness W2 is smaller than the thickness W1.

As described above, according to the present embodiment, even when the battery cells 2 expand during use, each pair of ribs 24 provided inside each cooling section 21 comes into contact with each other. This can reduce the possibility of the channels 23 becoming fully collapsed. As a result, the cross-sectional area of the channels 23 can be maintained, and the cooling performance can be ensured.

The number of battery cells 2 is not particularly limited. The number of battery cells 2 stacked in the X-direction is not limited. A structure in which the battery cells 2 are arranged side by side in the Y-direction may also be used.

The shape of the ribs 24 is not limited to the linear shape illustrated in FIG. 4 etc. The ribs 24 may have a curved shape. Similarly, the shape of the deformable portions 21a is not limited to the V-shape or the inverted V-shape, and may be a curved shape.

The first contact portion 25 and the second contact portion 26 are not limited to the shapes that make line contact with each other. The first contact portion 25 and the second contact portion 26 may have shapes that make surface contact with each other.

The number of contact portions provided on the rib 24 is not particularly limited. The first rib 41 may include a plurality of first contact portions 25 between the first connection point 51 and the second connection point 52. The second rib 42 may include a plurality of second contact portions 26 between the third connection point 53 and the fourth connection point 54.

What is claimed is:

1. A cooler disposed inside a case that houses a battery and configured to cool the battery, the cooler comprising a cooling section disposed in a stack of a plurality of the batteries at a position between adjacent ones of the batteries in a stacking direction of the stack, wherein:
the cooling section includes
a channel through which coolant flows in a width direction perpendicular to the stacking direction,
a first cooling surface that contacts one of the adjacent batteries,
a second cooling surface that contacts the other of the adjacent batteries, and
a plurality of ribs each extending so as to connect a first inner surface that is a back surface of the first cooling surface and a second inner surface that is a back surface of the second cooling surface, the ribs being deformable in response to a change in a distance between the first inner surface and the second inner surface;
the ribs include a pair of ribs configured to deform to move away from each other when a distance between the first inner surface and the second inner surface changes in a direction in which the distance increases, and configured to deform to move toward each other when the distance between the first inner surface and the second inner surface changes in a direction in which the distance decreases; and
the pair of ribs is configured to contact each other when the battery expands and the distance between the first inner surface and the second inner surface is reduced to a predetermined amount, and in a state in which the pair of ribs is in contact with each other, support each other such that the first inner surface and the second inner surface do not come any closer.

2. The cooler according to claim 1, wherein:
the pair of ribs includes
a first rib including a first contact portion, and
a second rib disposed so as to face the first rib and including a second contact portion configured to contact the first contact portion;
the first contact portion is located closer to the second rib than a first connection point at which the first rib is connected to the first inner surface and a second connection point at which the first rib is connected to the second inner surface;
the second contact portion is located closer to the first rib than a third connection point at which the second rib is connected to the first inner surface and a fourth connection point at which the second rib is connected to the second inner surface; and
the pair of ribs is configured to come into contact with each other when the first contact portion and the second contact portion contact each other.

3. The cooler according to claim 2, wherein a distance between the first connection point and the third connection point is smaller than a sum of a distance from the first connection point to the first contact portion and a distance from the third connection point to the second contact portion.

4. The cooler according to claim 3, wherein a distance between the second connection point and the fourth connection point is smaller than a sum of a distance from the second connection point to the first contact portion and a distance from the fourth connection point to the second contact portion.

5. A method for manufacturing a battery pack including the cooler according to claim 1, the method comprising:
an insertion step of, in a state in which a cooling device is placed inside a case that houses a plurality of battery cells, inserting each of the battery cells between corresponding adjacent ones of the coolers, the cooling device including a structure in which the coolers are arranged such that cooling surfaces of the coolers face each other; and
a deformation step of, after insertion of each of the battery cells between the corresponding adjacent ones of the coolers, increasing internal pressure of the cooler to deform the cooler such that the cooling surface comes into contact with the battery cell, wherein:
in the insertion step, the pair of ribs inside the cooler is in a separated state; and
the deformation step includes deforming the pair of ribs such that the pair of ribs moves away from each other and displacing the cooling surface in the stacking direction as the cooler is deformed to increase a thickness of the cooler.
